(19) United States
(12) Patent Application Publication
(10) Pub. No.: US 2017/0219374 A1
(43) Pub. Date: Aug. 3, 2017

(54) NAVIGATION SYSTEM AND METHOD FOR DETERMINING A VEHICLE ROUTE OPTIMIZED FOR MAXIMUM SOLAR ENERGY RECEPTION

(71) Applicant: Toyota Motor Engineering & Manufacturing North America, Inc., Erlanger, KY (US)

(72) Inventors: Nicholas S. Sitarski, Ypsilanti, MI (US); Eric R. Schmidt, Northville, MI (US)

(21) Appl. No.: 15/008,525

(22) Filed: Jan. 28, 2016

(51) Int. Cl. G01C 21/36; G01C 21/20

(52) U.S. Cl. CPC G01C 21/3691; G01C 21/20

(57) ABSTRACT

A computing device for a vehicle configured to utilize solar energy is provided. The computing device includes one or more processors for controlling operation of the computing device, and a memory for storing data and program instructions usable by the one or more processors. The one or more processors include circuitry configured for, responsive to instructions stored in the memory determining at least one travel route from a current location of the vehicle to a destination of the vehicle; determining an estimated solar energy reception for the at least one travel route; and providing a notification relating to the at least one travel route, the notification including information representing the estimated vehicle solar energy reception for the at least one travel route.

### TECHNICAL FIELD

Aspects of the disclosure generally relate to optimization of a travel route of a vehicle configured to absorb and utilize solar energy, to provide maximum solar energy exposure and reception while traveling along the route.

### BACKGROUND

In vehicles incorporating solar panels or configured to absorb and utilize solar energy for various purposes, the driver may desire the option of tailoring a driving route for maximum exposure to sunlight, so that maximum solar energy may be received during a trip. However, the amount of solar energy incident on a moving vehicle may depend on numerous factors, such as the angle of any vehicle solar panels with respect to incident sunlight, the degree of cloud cover over the driving route, the extent of shading of the road surfaces along the driving route, and other factors. Thus, it would be beneficial to have a navigation system and method for estimating the vehicle solar energy reception along as much of a proposed travel route as possible, to enable a user driving a solar-powered vehicle to receive the greatest amount of solar energy while traveling between a start point and a given destination.

### SUMMARY

In one aspect of the embodiments described herein, a computing device for a vehicle configured to utilize solar energy is provided. The computing device includes one or more processors for controlling operation of the computing device, and a memory for storing data and program instructions usable by the one or more processors. The one or more processors include circuitry configured for, responsive to instructions stored in the memory determining at least one travel route from a current location of the vehicle to a destination of the vehicle; determining an estimated solar energy reception for the at least one travel route; and providing a notification relating to the at least one travel route, the notification including information representing the estimated vehicle solar energy reception for the at least one travel route.

In another aspect of the embodiments of the described herein, a method for operating a navigation system for a vehicle is provided. The method includes steps of receiving a vehicle destination; determining a current position of the vehicle; determining at least one travel route from the current position to the destination; determining an estimated vehicle solar energy reception for the at least one travel route; and providing a notification including the estimated vehicle solar energy reception for the at least one travel route.

### BRIEF DESCRIPTION OF THE DRAWINGS

FIG. 1 is a block diagram of a navigation system in accordance with an embodiment described herein.

FIG. 2 illustrates a block diagram of a computing device in a navigation system in accordance with one or more illustrative embodiments described herein.

FIG. 3A is a street-level view of a portion of a road surface shaded by a tree T during a relatively earlier part of the day.

FIG. 3B is a plan view of the shaded road surface shown in FIG. 3A.

FIG. 4A is a street-level view of a portion of a road surface shaded by a tree T during a relatively later part of the day.

FIG. 4B is a plan view of the shaded road surface shown in FIG. 4A.

FIG. 5 is a block diagram showing a method for operating a navigation system for a vehicle, in accordance with an embodiment described herein.

FIG. 6 is a block diagram of an exemplary method of calculating or determining a vehicle solar energy reception for a travel route, in accordance with an embodiment described herein.

### DETAILED DESCRIPTION

The navigation system embodiments described herein calculate one or more travel routes between a current vehicle location and a destination. The embodiments are also configured to determine an estimated solar energy reception for each of the one or more routes calculated by the navigation system. The estimated solar energy reception for a given route represents a predicted solar energy absorption of a vehicle traveling the route. The estimated solar energy reception for a given route may be derived by calculating or determining one or more of a weather component, a shading component, a travel period component, and a latitude component of the route. Each component may be determined based on the availability of the information needed to determine the component. If information relating to only one component is available for a given route, the estimated solar energy reception for the route may be assigned the value of this component. If information relating to more than one of the components is available thereby enabling multiple components to be determined, the multiple components may be combined to generate the estimated solar energy reception for the route.

On some vehicles configured for solar energy usage, the vehicle may be capable of actively adjusting solar panels so as to achieve a more favorable angle of incidence of sunlight on the panels. This enables increased and more efficient absorption of solar energy. Vehicles may also employ mirrors configured for automatically adjusting to the angle of incident sunlight, to aid in concentrating or focusing the sunlight toward a receiver. The navigation system embodiments described herein are beneficial to vehicles incorporating such systems, but especially to vehicles which lack such capabilities. Using a navigation system as described herein, vehicles which lack adjustable mirrors, adjustable solar panels and similar technologies may be exposed a relatively greater amount of solar energy than would otherwise be the case, due to route optimization performed before (and, optionally during) travel.

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

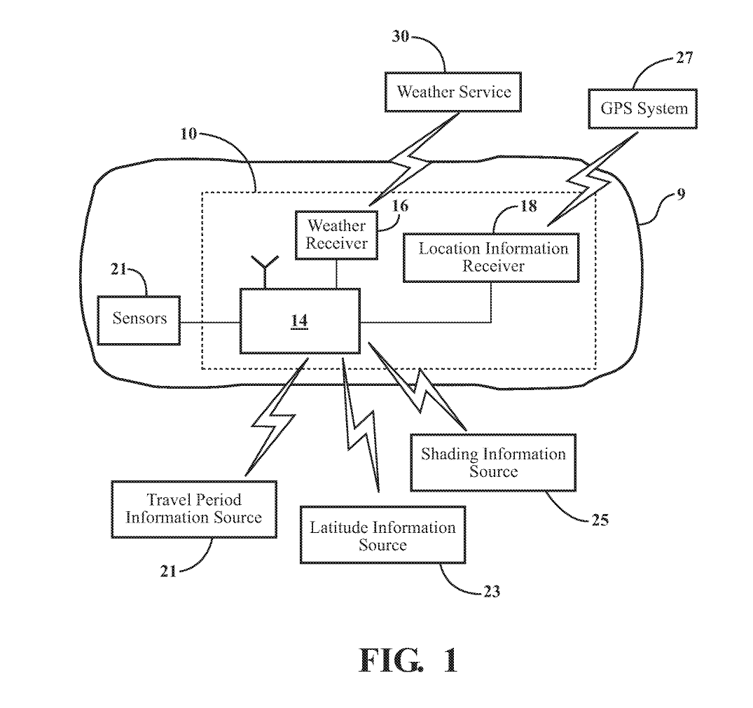

FIG. 1 is a block diagram of a navigation system 10 in accordance with an embodiment described herein. Navigation system 10 is shown incorporated into a vehicle 9. In the embodiment shown, system 10 includes a computing device 14, a weather receiver 16 in operative communication with the computing device, and a vehicle location information receiver 18 in operative communication with the computing device.

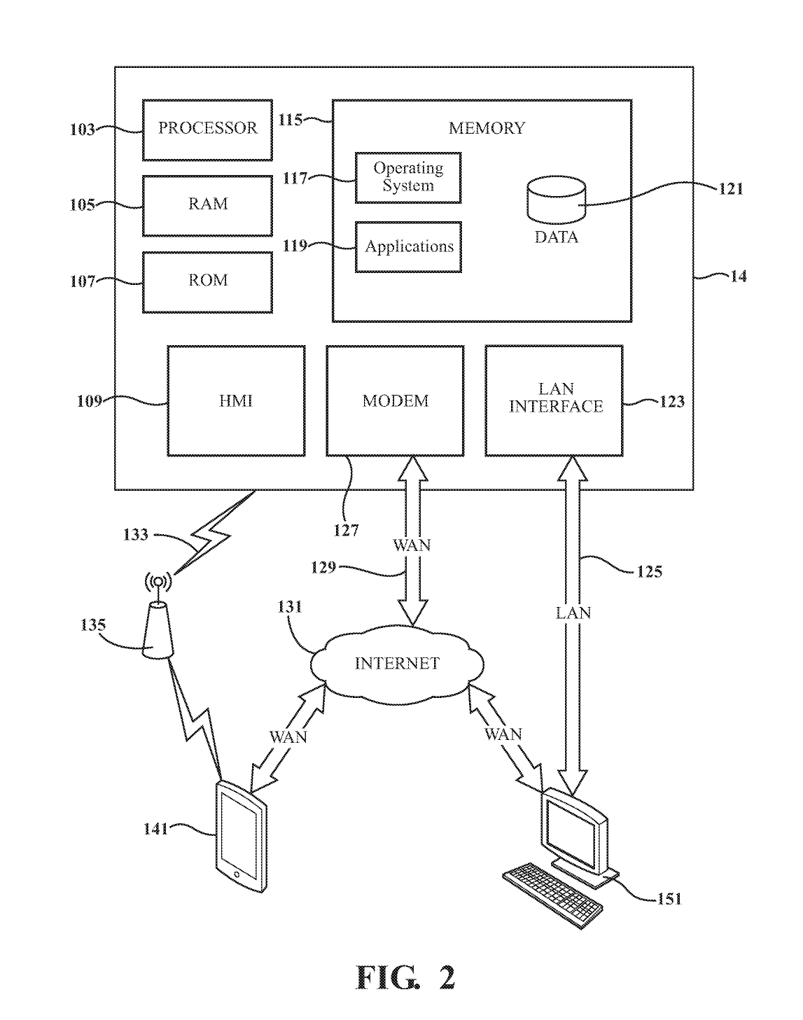

FIG. 2 illustrates a block diagram of a computing device 14 in a navigation system that may be used according to one or more illustrative embodiments of the disclosure. The computing device 14 may have one or more processors 103 for controlling overall operation of the device 14 and its associated components, including RAM 105, ROM 107, input/output module or HMI (human machine interface) 109, and memory 115.

Input/Output (I/O) or human-machine interface (HMI) 109 may include a microphone, keypad, touch screen, and/or stylus through which a user of the computing device 14 may provide input, and may also include one or more of a speaker for providing audio output and a video display device for providing textual, audio, audiovisual and/or graphical output. Software may be stored within memory 115 and/or storage to provide instructions to processor 103 for enabling device 14 to perform various functions. For example, memory 115 may store software used by the device 14, such as an operating system 117, application programs 119, and an associated internal database 121.

Processor 103 and its associated components may enable the navigation system 200 to execute a series of computer-readable instructions directed to performing the various functions and method steps recited herein.

The navigation system computing device 14 may operate in a networked environment supporting connections to one or more remote computers or devices, such as 141 and 151. Computing device 14 and related terminals/devices 141 and 151 may include devices installed in vehicles, mobile devices that may travel within vehicles, or devices outside of vehicles that are configured to receive vehicle and user position information and destination information, and to calculate travel routes, estimated solar energy receptions and route solar optimization components as described herein. Thus, the computing device 14 and terminals/devices 141 and 151 may each be embodied in personal computers (e.g., laptop, desktop, or tablet computers), servers (e.g., web servers, database servers), vehicle-based devices (e.g., on-board vehicle computers, short-range vehicle communication systems, telematics devices), or mobile communication devices (e.g., mobile phones, portable computing devices, and the like), and may include some or all of the elements described above with respect to the computing device 14. In addition, any of these computing device embodiments may include a haptic interface or may be configured to provide haptic feedback to a vehicle occupant to inform the occupant of a change in travel route parameters or any other status or condition which should be communicated to the vehicle occupant. The network connections depicted in FIG. 1 may include a local area network (LAN) 125 and a wide area network (WAN) 129, and a wireless telecommunications network 133, but may also include other networks. When used in a LAN networking environment, the hazard avoidance computing device 14 may be connected to the LAN 125 through a network interface or adapter 123. When used in a WAN networking environment, the device 14 may include a modem 127 or other means for establishing communications over the WAN 129, such as network 131 (e.g., the Internet). When used in a wireless telecommunications network 133, the device 14 may include one or more transceivers, digital signal processors, and additional circuitry and software for communicating with wireless computing devices 141 (e.g., mobile phones, short-range vehicle communication systems, vehicle telematics devices) via one or more network devices 135 (e.g., base transceiver stations) in the wireless network 133.

It will be appreciated that the network connections shown are illustrative and other means of establishing a communications link between the computing devices and/or systems may be used. The existence of any of various network protocols such as TCP/IP, Ethernet, FTP, HTTP and the like, and of various wireless communication technologies such as GSM, CDMA, WiFi, and WiMAX, is presumed, and the various devices and components described herein may be configured to communicate using any of these network protocols or technologies.

Computing device 14 is configured for receiving current vehicle position information and destination information, and for calculating one or more travel routes to the destination, in a manner known in the art. Computing device 14 is also configured for determining an estimated vehicle solar energy reception and the various components thereof for one or more calculated travel routes as described herein. Computing device 14 is also configured for providing a notification for communicating the estimated vehicle solar energy reception and other information relating to the calculated travel route. Computing device 14 may also be configured for determining, from a plurality of possible routes, a route having a highest estimated vehicle solar energy reception, and for providing a notification specifying the route having the highest estimated vehicle solar energy reception.

Memory 115 may contain navigational maps (for example, GPS maps) including information from which the various vehicle routes may be calculated. Shading information (such as stored shading factors for various streets, highways, etc., satellite images, maps, functions used to calculate shading factors or components, etc.) usable for determining the shading component of a given travel route as described herein may be stored on memory 115 or on a separate memory (not shown) accessible by the computing device through wireless or wired communication. Alternatively, elements of the shading information may be located on both memory 115 and another memory.

A vehicle location information receiver 18 (for example, a known GPS receiving apparatus) is configured to receive vehicle current location information (for example, GPS coordinates). The location information is used in planning and updating vehicle travel routes, in a manner known in the art. The location receiver may be embodied in a device separate from the computing device 14 and in operative communication with the computing device, as shown in FIG. 1. Alternatively, location receiver 22 may be incorporated into navigation system 10 as a part of computing device 14 which is in operative communication with other elements of the computing device.

A weather receiver 26 is in communication with computing device 14 and is configured to receive weather information usable in determining a weather component of an estimated solar energy reception for a given route, as described herein. The information may include weather forecasts about weather on a route from a starting point to a destination which has been calculated by the navigation computing device 14.

It is desirable that weather-related information be as timely as possible. A weather service provider 30 may provide weather forecasts including such parameters as temperature, wind, precipitation and sunshine, for example. There are various online database providers which allow access to detailed real-time weather conditions for specific locations as well as forecasts as far as a few days in the future, for example up to 10 or 14 days. Weather forecasts may be received from public services via a wireless connection, for example a radio frequency connection based on GSM, GPRS, UMTS or WLAN. For temperature validation and more accurate values, the current weather conditions in the vicinity of the vehicle may be measured by onboard vehicle sensors 21, e.g. temperature sensors and any other pertinent sensors incorporated into the vehicle.

Latitude information used for determining a latitude component of an estimated solar energy reception may be stored on memory 115 or may be provided by an independent latitude information source 23 (for example, a remotely located database) configured for wireless or wired communication with computing device 14.

Also, travel period information used for determining the travel period component of an estimated solar energy reception may be stored on memory 115 or may be provided by an independent travel period information source 21 (for example, a remotely located database) configured for wireless or wired communication with computing device 14.

Embodiments of the navigation system described herein are configured to calculate one or more routes from a current vehicle position to a desired destination, in a manner known in the art. Embodiments of the navigation system described herein are also configured to determine an estimated solar energy reception pertaining to any travel route calculated by the navigation system and/or to any portions of a calculated route for which solar energy determination information is available. An estimated solar energy reception for a route or portion of a route is a representation of the estimated solar energy that will be received by the vehicle while traveling the route. In one embodiment, the estimated solar energy reception is derived from several components, namely a shading component, a weather component, a latitude component and a travel period component.

One factor affecting the solar energy received by a moving vehicle is the shading which occurs when direct sunlight is prevented from reaching the vehicle due to an obstruction (such as trees, terrain features or buildings) positioned between the sun and the moving vehicle so as to cast a shadow on the road surface where the vehicle is traveling. In the embodiments described herein, the shading component used for solar energy route optimization is determined from shading caused by relatively fixed and/or permanent objects and/or structures positioned on the road or adjacent the road, and casting a shadow on the road. Shading of the road surfaces due to airborne phenomena such as clouds or smoke is characterized as part of a weather component.

Factors affecting the shading component of a given length of road surface include the height of an object (such as trees, buildings, etc.) adjacent the road and casting a shadow on the road. Taller objects will cover more of the adjacent road surface for a given angle at which the sunlight strikes the road surface. Another factor is the volume of the object. Objects having a larger volume such as buildings and large trees will cast a correspondingly larger shadow on the road surface. Another factor is the distance of the object from an edge of the road. For example, trees spaced more closely to the road may overhang the road and cast a shadow on the road even when sunlight strikes the road from directly overhead. Another factor is the width of the road. A relatively wider road (such as an expressway) will provide have a relatively greater open area between edges of the road. Another factor is the types of trees along a road. Some types of trees will shed leaves during the fall, while other types of trees (for example, evergreens) do not. This affects the total area of shadow projected by the trees on the road surface at various time of the year. Another factor is the spacing of the trees and/or buildings along a road. Trees and/or buildings may be unevenly spaced along a street, with small groupings of closely spaced trees and/or buildings interspersed with relatively open spaces containing few or no such structures. In addition, the shadows cast by trees and buildings will change and combine in various ways during various times of day as the angle of the sun changes. Thus, another factor affecting shading is the time of day during which the vehicle is being driven.

For purposes of estimating the route calculated to maximize the solar energy incident on the vehicle, the impact of all of these factors may be accounted for by generating shading maps of the road surfaces residing in the regions to be traveled. Shading maps indicate shaded or shadowed areas on a road surface which are due to fixed and/or permanent objects such as buildings, terrain features, and trees, for example. Shading maps of a particular length of road may be generated from data regarding the shading of the road by trees, buildings, etc. In one embodiment, the data used to form the shading map is extracted from satellite photographs of the particular street or stretch of road. In one method, initial photographs of the stretch of road may be taken at various times over a single day during the local winter months. This day may be, for example, the day of the winter solstice. This provides a reference point for the shortest period of light and longest period of darkness that a particular latitude will experience in a year. Photos may be taken at various points in time between dawn and dusk on the chosen day, with one photo taken at a time of day calculated to coincide with the maximum height of the sun. Taken together, these photos provide a record of the degree to which the given stretch of road surface is covered or shaded by objects such as trees, buildings, etc., during various times of the day. The procedure described above may also be followed for a single day during the summer months. In one embodiment, photographs are taken during the day of the summer solstice. This provides a reference point for the longest period of light and shortest period of darkness that a particular latitude will experience in a year.

The photographs are analyzed to determine the percentage of road surface shaded or covered by shadows during the time when the photos were taken. The percentage of road surface area covered shaded by shadows will vary according to the time of day and time of year. As more and more photographs are taken and more data are collected, estimates regarding the shading of a particular road may be made with increasing accuracy. For example, photos of a given road may be taken over a single day at one-hour intervals. From these photos, the variation of the shadow coverage area for the given road section at the different times of day may be estimated.

The shading on some sections of road will vary little, if at all. Expressways, for example, which are relatively wide and may experience little or no shading due to trees and buildings, will have correspondingly little or no variation in shading with respect to the time of day. Thus, the data needed for shading mapping of expressways and stretches of roadway having similar configurations may be obtained from relatively fewer photographs, because the degree of shadowing will not vary with the time of day or time of year. Similarly, streets surrounded by tall buildings may be in constant shadow, regardless of the time of day or the angle of the sun with respect to the ground. Thus, the data needed for shading mapping of city streets surrounded by tall buildings may be obtained from relatively fewer photographs, because the degree of shadowing will not vary with the time of day or time of year. In contrast, for relatively narrower streets and buildings having trees positioned close to the street and/or trees and buildings which are spaced unevenly along the street, a relatively greater number for photographs may be required to provide an accurate assessment of how the street shadowing varies during the day. Also, the length of road along which the photos are taken may need to be reduced to provide increased resolution and accuracy.

Using the gathered satellite images and known techniques, the percentage of a given length of road surface covered by shadow at a given time of day may be determined or estimated to provide a shading factor for the given stretch of road at the given time of day. If sufficient data is collected regarding a particular stretch of road at various times of the day and year, a function or formula may be generated for estimating the shadowing factor or percentage of shading for a given stretch of road based on the time of day and time of year. The collected data and any functions, formulae and/or estimates of shading factors may be stored in memory, in databases, lookup tables, etc. The shading factors for the lengths of road forming the proposed travel route may be combined and, if desired, weighted using known techniques (and considering factors such as, for example, the length of road affected). In this manner, a composite, route shading component may be generated for any given route as a function of the shading factors of the road sections from which the route is composed. This information may then be used in optimizing the vehicle route for maximum solar radiation reception during travel.

As an alternative (or in addition to) conventional satellite photos, satellite thermal imaging may be used to gather images suitable for the analysis just described, as the shaded areas will be cooler than surrounding areas. Other sources of shading information include images taken by vehicle occupants riding along the roads in question and any other suitable sources.

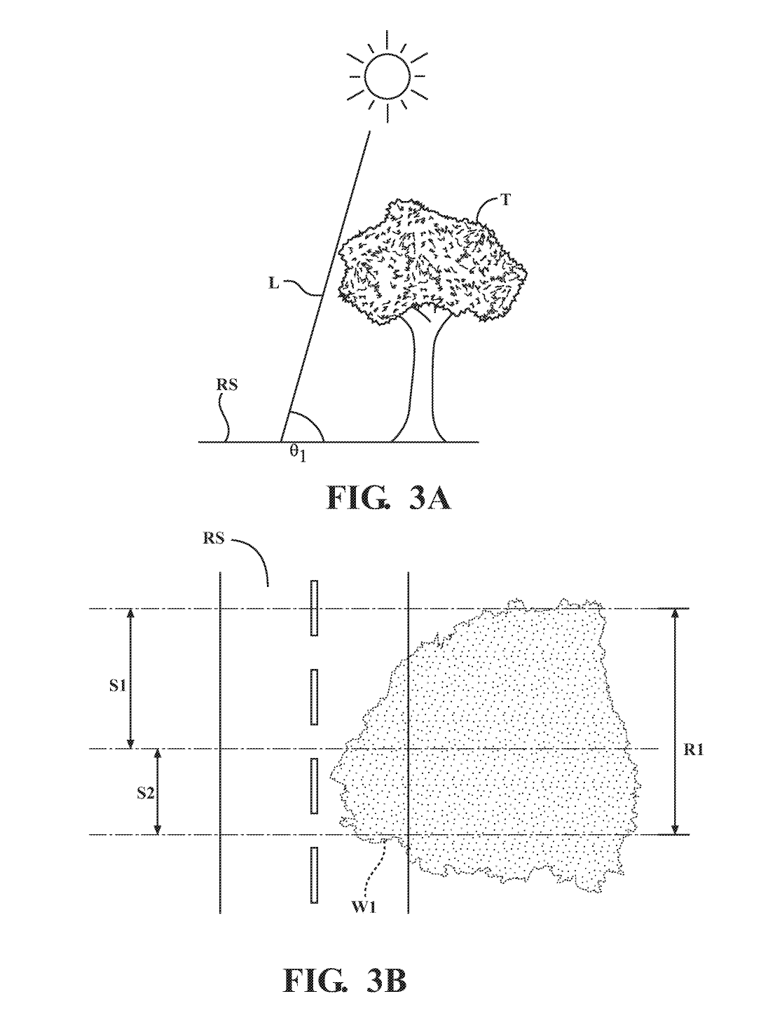

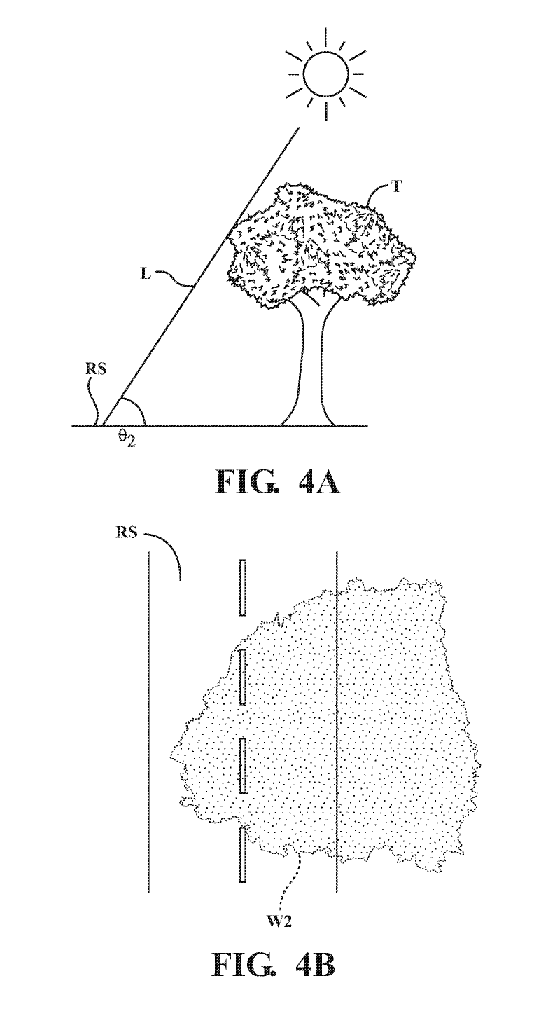

FIGS. 3A-3B and 4A-4B are schematic diagrams illustrating the change in shaded road surface area with the movement of the sun. FIG. 3A is a street-level view of a portion of a road surface shaded by a tree T during a relatively earlier part of the day. FIG. 3B is a plan view of the shaded road surface shown in FIG. 3A. FIG. 4A is a street-level view of a portion of a road surface shaded by a tree T during a relatively later part of the day. FIG. 4B is a plan view of the shaded road surface shown in FIG. 4A.

In a first, earlier part of a day represented in FIGS. 3A and 3B, sunlight L makes a first angle θ₁ with the road surface RS and a tree T casts a shadow W1 on the road surface. In a second, later part of the day represented in FIGS. 4A and 4B, sunlight L makes a second angle θ₂ with the road surface RS, and tree T casts a shadow W2 on the road surface. Because angle θ₂ is less than angle θ₁, the area of shadow W2 is greater than the area of shadow W1. Plan views of road surfaces such as shown in FIGS. 3B and 4B may be obtained from satellite photos. Then, referring to FIG. 3B, for each section of road S1, S2, etc., at a given point in time, a shading factor for each section of road examined may be calculated based on the percentage of road area that is shaded on that section of road.

The shading factors for adjacent or contiguous road sections S1 and S2 can be combined to form a shading component of a portion R1 of a route formed by the contiguous road sections. This procedure may be executed for all portions of a route for which shading information is available. This procedure may be executed for differing lengths of roadway depending on the types and sizes of structures producing the shading, and other pertinent factors. By reducing the length of road surface analyzed, a more accurate estimate of the shading area may be provided).

Prior to the need for determination of a shading component, shading factors can be calculated or determined and assigned to each stretch of road for which shading maps are available, for the time of day at which the route is to be traveled. For sections of road where the amount of shading changes over relatively short lengths of road, the section of road may be divided into shorter lengths for processing as previously described. For any calculated route for which shading maps are available, a composite shading component for the route may be calculated by summing or otherwise combining the individual shading components for the route. For sections of the route where no shading maps are available, these sections of road may be omitted from the determination of shading component and a message to this effect can be presented to a user. Information used in determining a shading component for a route or a portion of a route may be provided by a shading information source 25 (for example, a remotely located database) configured for wireless or wired communication with computing device 14.

In a particular embodiment, the above-described shading analysis of the available satellite photos is conducted prior to the need for route information. Calculated shading factors or derived functions or formulae usable for determining the shading factors portions of various sections of roads may be stored in memory (for example, in lookup tables) in shading information source 25 or other storage remote from the vehicle. When a route has been calculated by the computing device 14, any available shading information for the road sections included in the route may be accessed by computing device using a suitable wireless connection. Map information containing the pertinent shading information may also (or alternatively) be stored in memory 115 of computing device.

In addition, map information enabling determination of the travel period and latitude components (described below) of the estimated solar energy reception for a given route may be stored remotely from the vehicle and/or in memory 115. Remote storage of the map information enabling determination of the shading, travel period and latitude components may enable this information to be updated more readily as additional or more accurate information becomes available.

The estimated vehicle solar energy reception of a given route may also have a weather component. The weather component is based primarily on a cloud component and a temperature component, although other factors may be considered if desired or if information is available. The cloud and temperature components may be combined to provide a composite weather component.

Because clouds reduce the amount of solar energy reaching vehicle solar panels, a cloud component may be calculated and factored into the route calculation and/or selection. Routes having relatively lower cloud coverage may be determined to have a relatively lower cloud component, which would be a desirable characteristic of a solar energy-optimized route.

Sources of information relating to cloud cover over a given portion of road may include satellite photos, information from ground observers, the weather service information previously described and other sources. Information from these sources may be combined and collated to estimate the cloud coverage over a given portion of the route.

In addition, solar panel efficiency may be adversely affected if the panel temperature exceeds a predetermined temperature. Thus, a temperature component of the weather component may also be calculated and factored into the route calculation and/or selection. For this purpose, a relatively higher solar energy reception score may be given for a route along which the estimated temperature during the time of travel is relatively low or at least below a temperature value at which the solar panel efficiency would be adversely affected. This would be a desirable characteristic of a solar-energy optimized vehicle route. Therefore, due to the changeable nature of the weather, the cloud coverage and temperature estimates would ideally be dynamically updated as frequently as possible to enable the weather component of the estimated solar energy reception to be updated in as closely to real-time as possible.

Because the angle of incident sunlight with respect to the earth's surface is different at different times of the year, the percentage of road surface covered by shadows will also vary according to the time of year. Solar insolation may be defined as a measure of the solar radiation energy received on a given surface area in a given time. Factors affecting solar insolation include the latitude of the location in question, weather patterns, and the time of year during which the insolation is measured. For example, locations along the same latitude will experience average levels of sunlight or incident solar energy exposure that are different during winter than during summer.

Also, locations along higher latitudes will generally receive lower levels of solar energy than locations along lower latitudes or along the equator. Thus, for purposes of maximizing the solar energy received during a trip, it may be desirable to travel at the lowest possible latitude for as long as possible during the trip. Also, for maximum solar energy reception, it may be desirable to travel the lowest latitude portion of the trip during the time of day when the sun is in the most favorable position in the sky.

The navigation system may be configured to account for these factors when calculating the estimated solar energy reception for a given route. Estimates of the average solar insolation at a given latitude for a given day of the year may be stored in lookup tables. The latitude component of the estimated solar energy reception of a proposed travel route may be determined by referring to the insolation values for the road sections forming the proposed route. These values may be averaged or otherwise suitably combined to provide a composite latitude component of the estimated solar energy reception. For example, a time-weighted average using an estimated time to be spent driving at each latitude and the estimated insolation values at the latitude may be used.

The travel period component of the estimated vehicle solar energy reception depends on the time of day in which the vehicle is to be traveling. The angle that the sun makes with the ground will vary with the time of day. For example, the sun will be higher in the sky during the middle of the day that at dawn or dusk. Satellite or weather service information received by computing device 14 via weather receiver 16 and may include the times at which dawn and dusk occur during a given day, and the time of day at which the sun will be at its highest point in the sky. This information may be used to assign a relatively high value to a travel period component, for example, if the vehicle is traveling during a period of the day in which the sun is relatively higher in the sky. In one particular embodiment, the travel period component is configured to range from a value of zero just before dawn and just after dusk. In between dawn and dusk, the travel period component may rise linearly from dawn to a maximum value when the sun is highest in the sky. The value may then fall linearly from the maximum value to zero at dusk.

Assignment of values to each of the shading, travel period, weather and latitude components may be undertaken so that a relatively higher value for each component indicates a relatively higher projected solar energy reception due to the effect represented by the associated component. Thus, for example, if a first route has a shading component value of 89 and a second route has a shading component value of 60, the route with a shading component of 89 would be less shaded-over than the route with a shading component of 60. Thus, the first route would be more desirable in having less road shading than the second route. In this manner, higher values of the various components for a given route would be indicative of a higher solar energy reception for that route. Also, if desired, the various components (shading, weather, latitude, and travel time) may be weighted according to their relative impact on solar energy reception in a given situation.

The estimated solar energy reception for a given route may be derived by calculating or determining one or more of a weather component, a shading component, a travel period component, and a latitude component of the route. If only one of the weather component, shading component, travel period component, or latitude component of the route is determined, the estimated solar energy reception may be assigned the value of this component. If more than one of the components is determined, the multiple components may be combined to generate the estimated solar energy reception for the route.

In addition to the components described above (shading, weather, latitude, and travel time), the navigation system may be configured to receive and process data relating to other solar energy related components, and to generate the other components for use in optimizing an associated route for solar energy reception. For example, the navigation system may be configured to calculate a fog component based on available weather data, ground observations, etc.

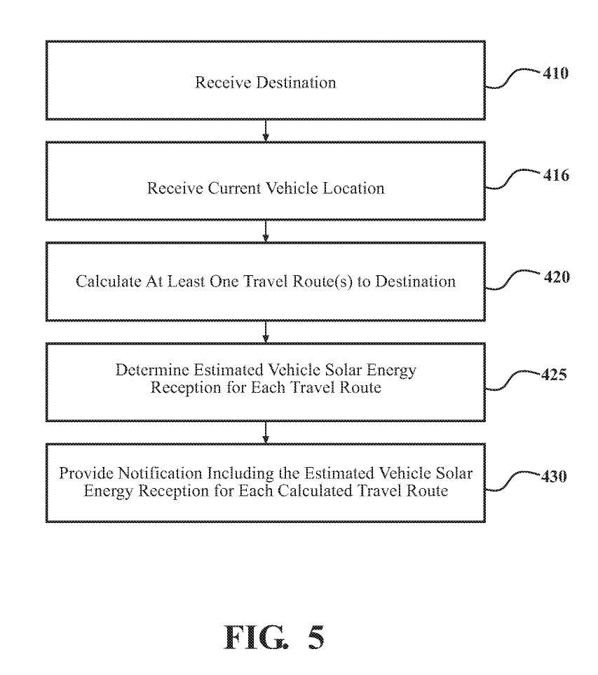

FIG. 5 is a block diagram of an exemplary method of calculating or determining an estimated vehicle solar energy reception for a travel route.

In block 410, a computing device receives a vehicle destination (for example, from a user via HMI 109).

In block 416, the location information receiver 18 receives current vehicle location information. Blocks 410 and 416 may be executed in any order, or simultaneously.

In block 420, at least one travel route is calculated in a known manner, using the current location and destination information. If desired, or as part of the system standard operating procedure, multiple alternative travel routes may be calculated at this time.

In block 425, an estimated vehicle solar energy reception is determined for each of the travel routes, using the procedures described herein.

In block 430, the details of each travel route (including the estimated vehicle solar energy reception for the travel route) are presented to a user for evaluation and route selection.

The navigation system may be configured to determine a plurality of travel routes from the current position to the destination, determine an estimated vehicle solar energy reception for each travel route of the plurality of travel routes, determine a route of the plurality of travel routes having a greatest estimated vehicle solar energy reception, and provide a notification of the route of the plurality of travel routes having the greatest estimated vehicle solar energy reception. Thus, the system may be configured to select for presentation to a user (or to otherwise emphasize to the user) the route that is projected to have the greatest solar energy reception.

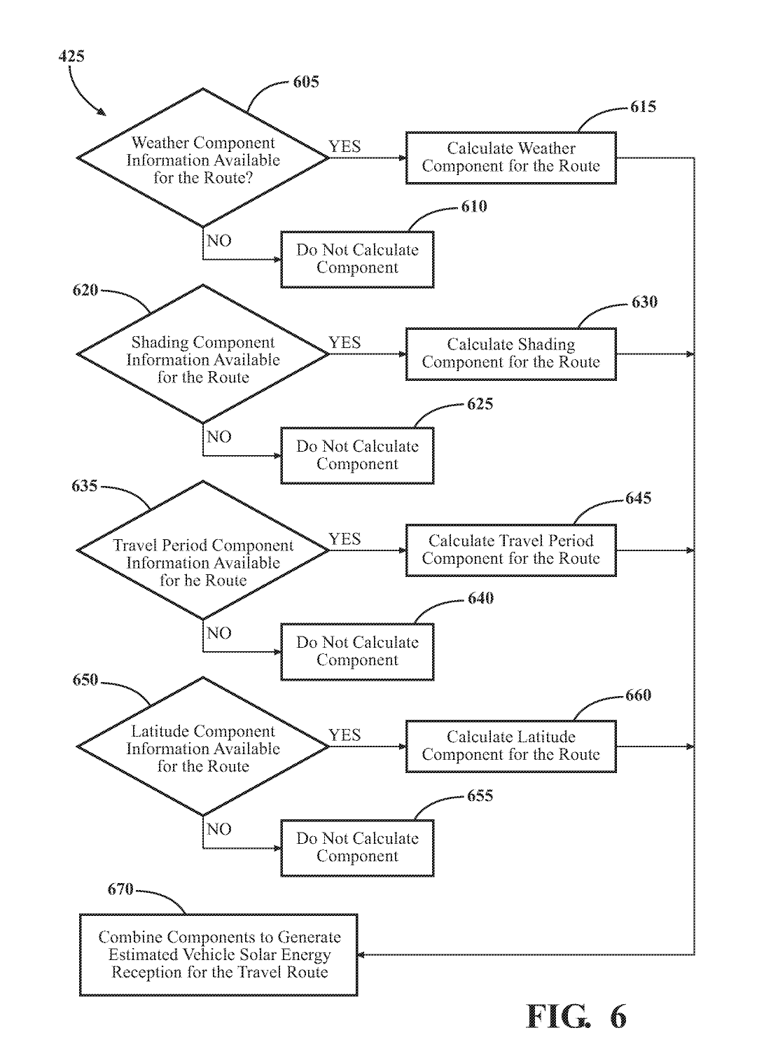

FIG. 6 is a block diagram showing a method for determining an estimated vehicle solar energy reception for a particular travel route, as previously recited in block 425. The procedure shown in FIG. 6 may be executed for each calculated route. The procedures indicated by blocks 605, 620, 635 and 650 may be executed one at a time, in any desired order, or these blocks may be executed simultaneously, depending on the capabilities of a particular computing device and the requirements of a particular application.

In certain cases, the information needed for an accurate and/or complete determination of one or more of the solar energy components may be lacking. For example, shading maps may be unavailable for portions of a proposed route, or a link to a weather satellite may be temporarily unavailable. If no (or insufficient) information is available for determining one or more of the solar energy components (weather, shading, travel route, or latitude) along a route, the estimated solar energy reception for the route may be determined using the components for which sufficient information is available. Similarly, if no (or insufficient) information is available for determining the impact of shading or weather along a portion of a proposed route, the impact of shading or weather along the route may be determined based on the portions of the route for which the necessary information is available.

Referring to FIG. 6, in block 605, the computing device 14 determines if sufficient information is available to determine a weather component for the given route. In block 615, if sufficient information exists, the computing device calculates or determined a weather component for the route. In block 610, if sufficient information does not exist or is unavailable, the computing device does not calculate or determine the weather component for the route.

In block 620, the computing device 14 determines if sufficient information is available to determine a shading component for the given route. In block 630, if sufficient information exists, the computing device calculates or determined a shading component for the route. In block 625, if sufficient information does not exist or is unavailable, the computing device does not calculate or determine the shading component for the route.

In block 635, the computing device 14 determines if sufficient information is available to determine a travel period component for the given route. In block 645, if sufficient information exists, the computing device calculates or determined a travel period component for the route. In block 640, if sufficient information does not exist or is unavailable, the computing device does not calculate or determine the travel period component for the route.

In block 650, the computing device 14 determines if sufficient information is available to determine a latitude component for the given route. In block 660, if sufficient information exists, the computing device calculates or determined a latitude component for the route. In block 665, if sufficient information does not exist or is unavailable, the computing device does not calculate or determine the latitude component for the route.

In block 670, all of the available components are combined to generate an estimated vehicle solar energy reception for the travel route.

Any suitable method of combining the components may be used. For example, certain components may be weighted more heavily than other components, based on the relative solar energy contributions of each component to a given vehicle design or solar energy absorption technology.

If desired, during travel along a selected route, the system may also be configured to recalculate the estimated solar energy reception for the selected route and also to determine the estimated solar energy reception for one or more possible alternative routes proceeding from a current location of the vehicle. The system may then provide notifications of the new route options and their associated estimated solar energy reception values. This provides the user with an opportunity to take advantage of, for example, changes in weather or route information availability which may occur during travel. The user may choose to make adjustments to the travel route based on the revised solar energy reception determinations.

In one particular embodiment, the revised solar energy reception determinations are made after the vehicle has traveled a predetermined distance from its start location. The user may also configure the navigation system to perform revised solar energy reception determinations at one or more pre-selected distances from the start location, or otherwise at various locations along the route. For example, the user may configure the system to perform the re-determinations “every X miles”.

Alternatively, the user may configure the navigation system to perform revised determinations at various times after the start of the journey along the selected route. The user may also configure the system to re-determine the solar energy reception at regular or pre-selected time intervals during travel. For example, the user may configure the system to perform the re-determinations “every X minutes”.

The system may also be configured to perform route and associated solar energy reception re-determinations on demand, whenever they are desired by the user. It should be understood that the preceding is merely a detailed description of various embodiments of this invention and that numerous changes to the disclosed embodiments can be made in accordance with the disclosure herein without departing from the spirit or scope of the invention. Thus, the disclosure is not to be limited to these embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A computing device for a vehicle configured to utilize solar energy, the computing device including one or more processors for controlling operation of the computing device, and a memory for storing data and program instructions usable by the one or more processors, wherein the one or more processors include circuitry configured for, responsive to instructions stored in the memory:
determining at least one travel route from a current location of the vehicle to a destination of the vehicle;
determining an estimated solar energy reception for the at least one travel route; and
providing a notification relating to the at least one travel route, the notification including information representing the estimated vehicle solar energy reception for the at least one travel route.

2. The computing device of claim 1 wherein the one or more processors include circuitry configured for, responsive to instructions stored in the memory, determining at least one of a weather component of the at least one travel route, a shading component of the at least one travel route, a travel period component of the at least one travel route, and a latitude component of the at least one travel route.

3. The computing device of claim 2 wherein the one or more processors include circuitry configured for, responsive to instructions stored in the memory, combining all available components of the weather component, shading component, travel period component, and latitude component to generate the solar energy component of the route.

4. The computing device of claim 1 wherein the one or more processors include circuitry configured for, responsive to instructions stored in the memory:
determining a plurality of travel routes from the current location of the vehicle to the destination of the vehicle;
determining an estimated solar energy reception for each route of the plurality of routes;
comparing the estimated solar energy receptions of the routes of the plurality of routes to determine a route with a highest estimated solar energy reception; and
providing a notification relating to the route with the highest estimated solar energy reception.

5. The computing device of claim 4 wherein the one or more processors include circuitry configured for, responsive to instructions stored in the memory, controlling the vehicle so as to travel the route with the highest estimated solar energy reception.

6. The computing device of claim 1 wherein the one or more processors include circuitry configured for, responsive to instructions stored in the memory and after a start of travel along a previously selected route:
determining a plurality of travel routes from the current location of the vehicle to the destination of the vehicle;
determining an estimated solar energy reception for each route of the plurality of routes;
comparing the estimated solar energy receptions of the routes of the plurality of routes to determine a route with a highest estimated solar energy reception; and
providing a notification relating to the route with the highest estimated solar energy reception.

7. A method for operating a navigation system for a vehicle, comprising steps of:
receiving a vehicle destination;
determining a current position of the vehicle;
determining at least one travel route from the current position to the destination;
determining an estimated relative vehicle solar energy reception for the at least one travel route; and
providing a notification including the relative vehicle solar energy reception for the at least one travel route.

8. The method of claim 7 wherein the step of determining at least one travel route from the current position to the destination includes determining a plurality of travel routes from the current position to the destination, the step of determining an estimated vehicle solar energy reception for the at least one travel route includes determining an estimated vehicle solar energy reception for each travel route of the plurality of travel routes, wherein the method further comprises the step of determining a route of the plurality of travel routes having a greatest estimated vehicle solar energy reception; and wherein the step of providing a notification includes providing a notification of the route of the plurality of travel routes having the greatest estimated vehicle solar energy reception.

9. The method of claim 7 wherein the step of determining an estimated vehicle solar energy reception for the at least one travel route comprises the steps of:
determining, in accordance with available information, at least one of a weather component of the at least one route, a shading component of the at least one route, a travel period component of the at least one route, and a latitude component of the at least one route; and
combining all available components of the weather component, shading component, travel period component, and latitude component to generate the solar energy component of the route.

10. The method of claim 9 wherein the step of determining at least one of a weather component of the route, a shading component of the route, a travel period component of the route, and a latitude component of the route comprises the step of determining a shading component for the route, and wherein the step of determining a shading component for the route comprises steps of:
determining portions of the at least one route for which a shading factor may be estimated for a proposed time of day of travel along the route;
for each portion of the at least one route for which a shading factor may be estimated, determining a shading factor of the portion of the route; and
combining the estimated shading factors of the portions of the route for which a shading factor may be estimated, to generate the shading component.

11. The method of claim 9 wherein the step of determining at least one of a weather component of the route, a shading component of the route, a travel period component of the route, and a latitude component of the route comprises the step of determining a weather component for the route, and wherein the step of determining a weather component for the route comprises steps of determining at least one of a cloud component and a temperature component of the weather component.

12. A vehicle navigation system including a computing device in accordance with claim 1.

13. A vehicle including a computing device in accordance with claim 1
